(19) United States
(12) Patent Application Publication
(10) Pub. No.: US 2012/0251227 A1
(43) Pub. Date: Oct. 4, 2012

(54) FASTENER FOR VINYL SIDING

(76) Inventor: Danny Owens, Martinsville, IN (US)

(21) Appl. No.: 13/078,235

(22) Filed: Apr. 1, 2011

(51) Int. Cl. F16B 7/04

(52) U.S. Cl. 403/300

(57) ABSTRACT

A fastener for connecting vinyl siding panels, including an elongated trough portion having a first flat portion, a second flat portion and a curved portion extending therebetween to define a J-shaped cross-section, a generally flat elongated portion, and a generally flat intermediate portion extending between and connecting the elongated trough portion and the generally flat elongated portion. The elongated trough portion, the generally flat intermediate portion and the generally flat elongated portion are sized and shaped to slidingly engage the top lock portion of a vinyl siding panel.

### TECHNICAL FIELD

The novel technology disclosed herein relates generally to mechanical fastener and, more specifically, to a fastener for connecting two vinyl siding panels.

### BACKGROUND

Vinyl siding has become ubiquitous as an exterior cladding material since its introduction in the late 1950s. Vinyl siding has achieved popularity as a building cladding material due to its durability, versatility and ease of maintenance. Vinyl siding enjoys the impact resistance, rigidity and strength afforded by its eponymous PVC polymer material component.

While vinyl siding has become the single most popular choice of exterior cladding across the United States and Canada and the siding itself has undergone great improvements in durability, ease of manufacture and the like, the mounting and connecting process has changed little over the last five decades. Vinyl siding panels A are manufactured with top locks B and buttlocks C at opposite ends that are configured to interlock with each other (see FIG. 1). The top locks B each further include nail hem portions D with elongated slots E through which nails may be inserted into nailable portions of the structure being clad, such as the underlying framework or studs. The elongated nail slots E allow the siding panel A to move as it expands and contracts with changing temperatures. This is called ‘loose fastening’. Thus, panels A have bottom locks or buttlocks C for securing into either a starter strip or onto the top lock B of the panel below, and the top lock B is then ‘loose’ nailed to hold the panel A to the wall, allowing the panels A to ‘float’ with the expansion and contraction from varying temperature and weather conditions. Likewise, adjacent panels A overlap each other at their side edges for a loose, floating connection (see FIG. 2).

Often, however, adjacent panels overlap between studs. When this occurs, there is no opportunity to secure the overlapping panels directly to the structure, creating a weakened overlap joint. These spots give rise to opportunities for water incursion, wind damage, small animal intrusion, and the like.

Thus, there is a need for a means of connecting overlapping vinyl siding panels at intersections where there is no nailable underpinning for locking down the panels. The present invention addresses this need.

### DESCRIPTION OF THE DRAWINGS

FIG. 1 is a partial perspective view of a prior art vinyl siding panel.

FIG. 2 is a partial perspective view of two overlapping prior art vinyl siding panels in place cladding a structure.

FIG. 3 is a perspective view of a fastener for connecting vinyl siding panels according to a first embodiment of the present novel technology.

FIG. 4 is a side elevation view of the fastener of FIG. 3.

FIG. 5 is a front plan view of the fastener of FIG. 3.

FIG. 6 is a perspective view of the fastener of FIG. 3 copnecting two overlapping vinyl siding panels.

FIG. 7 is an enlarged view of the fastener of FIG. 6 with the fingers extended.

FIG. 8 is an enlarged view of the fastener of FIG. 6 with the fingers partially bent around the siding panel.

FIG. 9 is an enlarged view of the fastener of FIG. 6 with the fingers bent to define a C-clamp engaged to the vinyl siding panel.

FIG. 10 is a front plan view of the fastener of FIG. 9.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

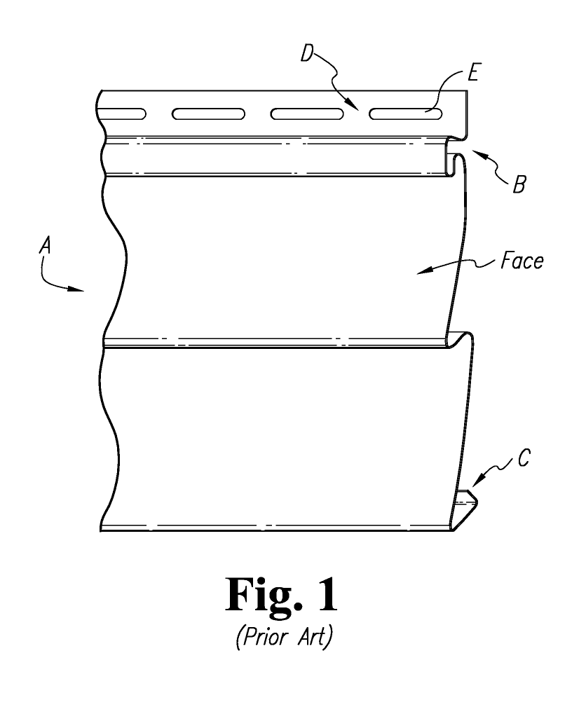

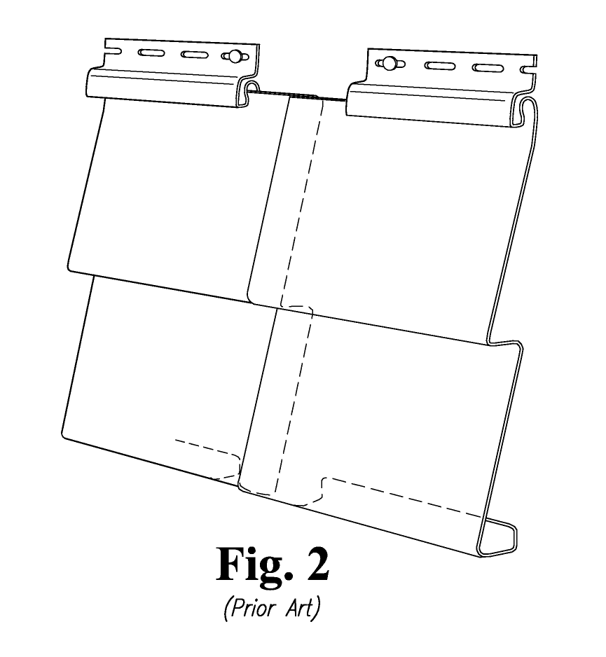

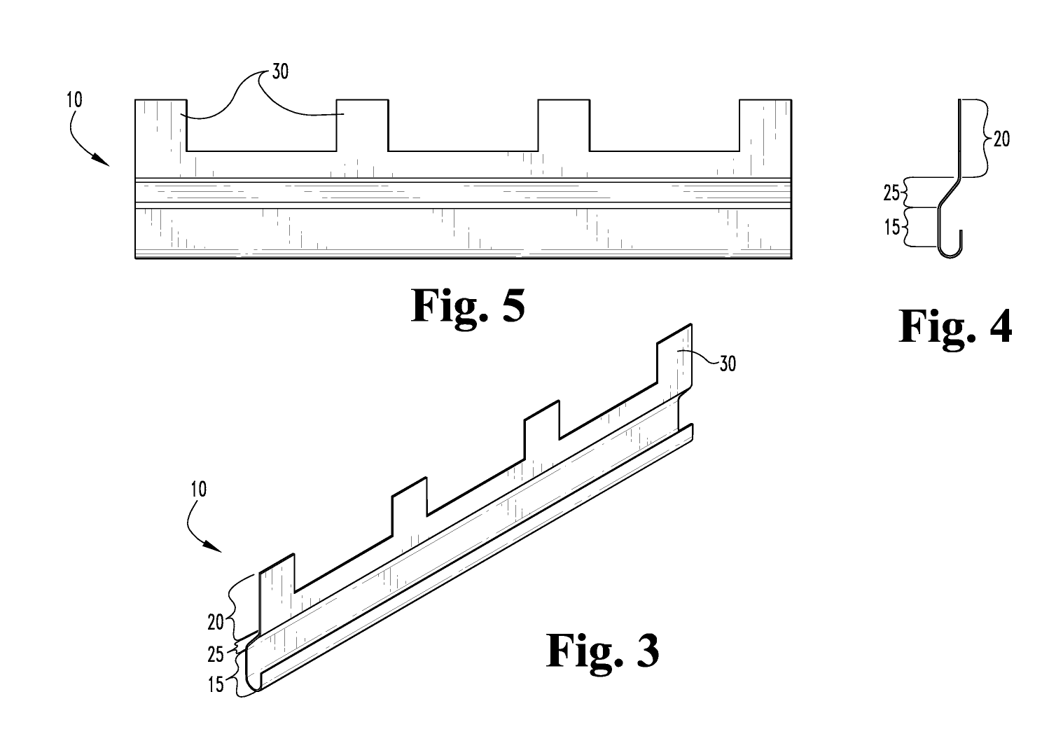

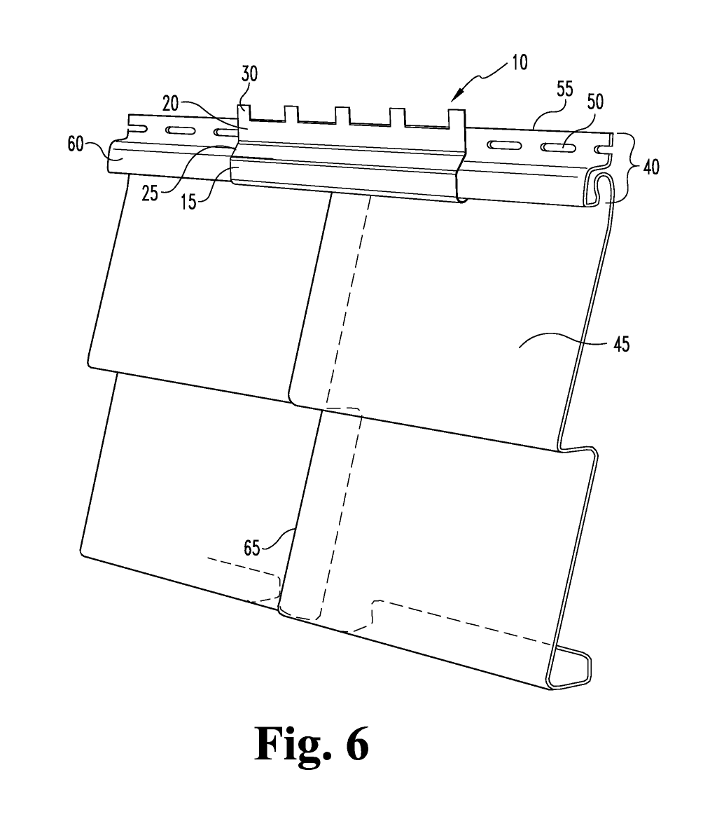

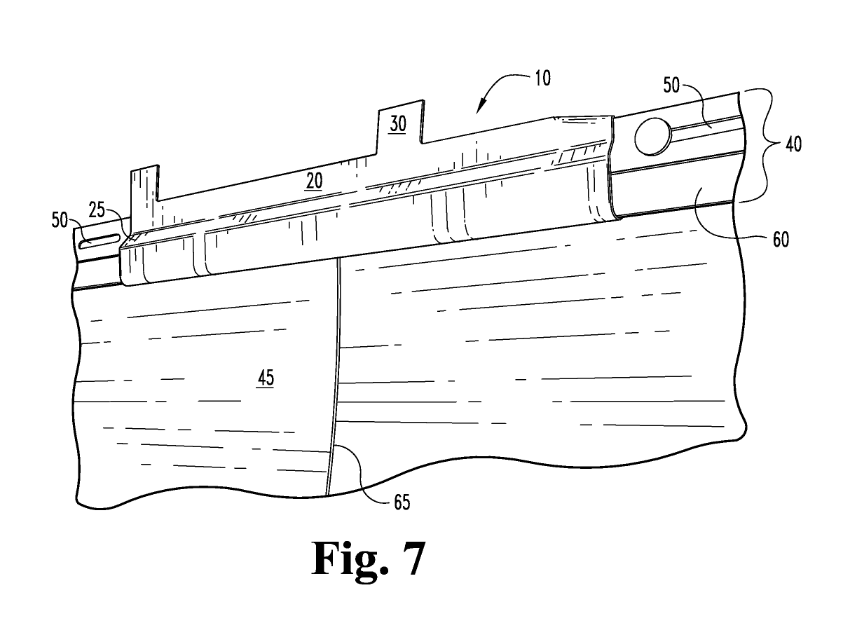

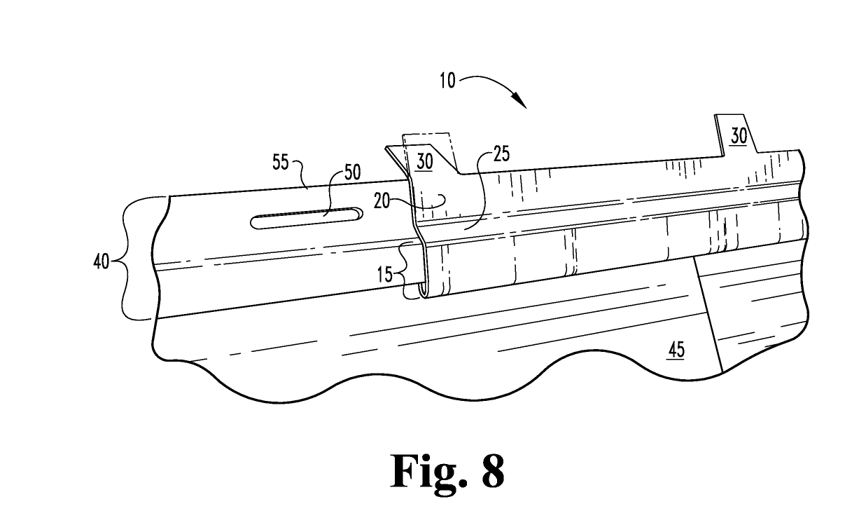

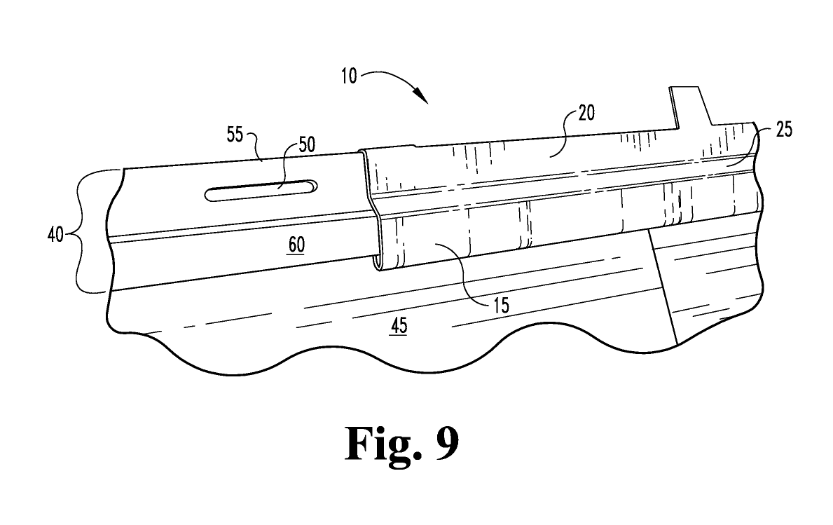

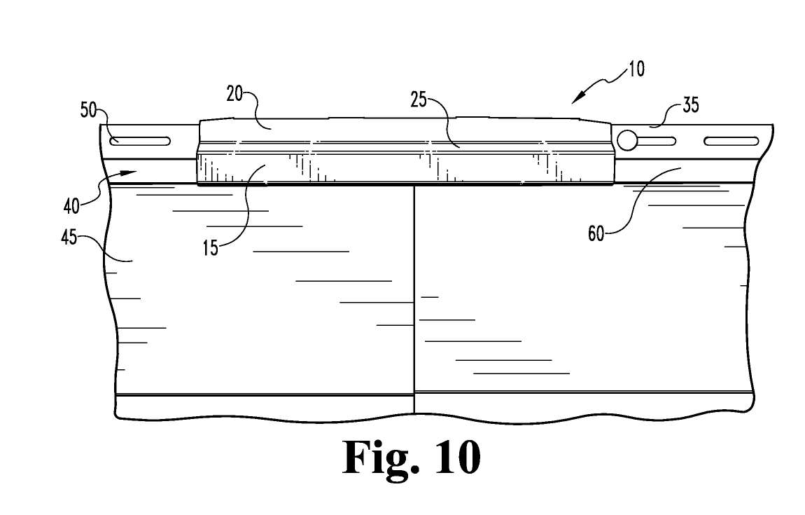

FIGS. 1-10 illustrate a first embodiment fastener 10 for connecting together two adjacent and typically overlapping vinyl siding panels. The fastener 10 has a lower trough portion 15 defing a J-shaped cross-section, a generally flat upper portion 20, and an angled connecting portion 25 extending therebetween. Taken together, the lower trough portion 15 defing a J-shaped cross-section, a generally flat upper portion 20, and an angled connecting portion 25 may be thouth to define an elongated body portion 27 defining a first major axis 29.

A plurality of distinct and typically flat elongated finger portions 30 extend from the flat upper portion 20. The finger portions 30 typically extend orthogonally to the major axis 29 or, in other words extend perpendicularly to the major axis 29 so as to form right angles at intersections therewith.

The trough portion 15 has a J-shaped cross-section and is sized and shaped to slidingly engage the top lock portion 40 of a vinyl siding panel 45. The angled connecting portion 15 generally follows the contour of the underlying vinyl siding panel 45, and the flat upper portion 20 generally flushly engages the portion of the top lock 40 having the elongated nail slots 50. Fingers 30 extend from the upper portion 20 and may be bent around the top lock portion 40 to engage the top lock portion 40 as C-clamps.

Fastener 10 is typically formed from a thin piece of metal of like structural material, such as aluminum or stainless steel. More typically, fastener 10 is formed from a rust-proof and weather resistant material. Still more typically, the finger portions 30 of fastener 10 are sufficiently pliable so as to be easily bent around the top lock portion 40 of a siding panel 45 to facilitate locking engagement thereto. In one particular embodiment, the fastener 10 is composed of 20 mil thick aluminum, the top portion 20, including the fingers 30, extends about 1 inch from middle connecting portion 25, each finger extends about 0.6 inches, the J-shaped portion 15 extends about 0.5 inches from the middle connecting portion 25, and the middle connecting portion 25 extends for about 0.3 inches between the other portions 15, 20. The length of the connector is about 8 inches.

Typically, the J-shaped portion 15 includes a first flat portion 50, a second generally flat portion 55 and a curved portion 60 connecting the flat portions 50, 55. Typically, the connecting portion 25 extends from the J-shaped portion 15 at an angle of about 40 degrees from the first flat portion 50, and the first flat portion and the upper portion 20 are generally parallel with each other. In the above embodiment, the width of the curved portion 60 defining the trough is about 0.3 inches and the second flat portion extends about 0.2 inches therefrom.

In operation, the fastener 10 is engaged to the top lock portion 40 of two overlapping vinyl siding sections 45. The respective top lock portions 40 each include a top edge portion 55 and a bottom contour portion 60. The vinyl siding sections 40 are first connected to the desired wall, either directly or through an intermediate backing panel, and positioned such that one panel overlaps the other, defining a seam or juncture 65. The fastener 10 is connected to the respective top lock portions 50 such that the J-shaped portion 15 accepts the respective bottom contour portions 60 and the fingers 30 are bent over and around the respective top edges 55 to define respective C-clamps engaging the top edges 55. The fastener 10 is typically loosely or slidingly connected to the top lock portions 50 such that movement of the panels 45 from expansion and contraction of the siding panels 45 may freely occur under the fastener 10.

The fastener 10 as connected and positioned over the seam or juncture 65 of the two panels 45 operates to prevent flexure of the panels 45 away from the wall to which they are affixed. This is especially fortuitous when the juncture 65 occurs away from a stud or other nailable backing, such that the panels are not directly fastened to the wall at or near the juncture 65. Without the presence of the fastener, high winds, animal activity, or the like may operate to pull the panels 45 outwardly away from the wall and each other, allowing the panels 45 to become partially or completely dislodged and/or allowing unwanted intrusion by water, dirt, insects, rodents and the like into the structure.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

1. A fastener for connecting vinyl siding panels, comprising:
an elongated trough portion having a first flat portion, a second flat portion and a curved portion extending therebetween to define a J-shaped cross-section;
a generally flat elongated portion; and
a generally flat intermediate portion extending between and connecting the elongated trough portion and the generally flat elongated portion;
wherein the elongated trough portion, the generally flat intermediate portion and the generally flat elongated portion are sized and shaped to slidingly engage the top lock portion of a vinyl siding panel.

2. The fastener of claim 1 and further comprising a plurality of spaced finger portions extending from the generally flat elongated portion.

3. The fastener of claim 2 wherein the respective finger portions are bendable to define respective C-clamps; and wherein the finger portions are positioned to bend around the top lock portion of an engaged vinyl siding panel to secure the fastener thereto.

4. A fastener for vinyl siding panels, comprising:
an elongated body portion contoured to matchingly engage a contoured top lock portion of a vinyl siding panel;
a plurality of elongated finger portions extending from the elongated body portion opposite the curved hook portion;
an elongated curved hook portion for lockingly engaging the contoured top lock portion of the vinyl siding panel;
wherein the elongated body portion is of sufficient length to straddle two overlapping vinyl siding panels; and
wherein the elongated body portion may be slidingly engaged to two overlapping vinyl siding panels.

5. The fastener of claim 4 wherein each respective finger may be bent to clampingly engage the vinyl siding panel.

6. The fastener of claim 5 wherein the elongated body portion defines a first major axis and wherein the respective fingers each extend orthogonally to the first major axis.
